(19) United States
(12) Patent Application Publication
(10) Pub. No.: US 2026/0364752 A1
(43) Pub. Date: Nov. 19, 2026

(54) SCREW HEAD REPLACEMENT TOOL

(71) Applicant: NISSEI PLASTIC INDUSTRIAL CO., LTD., Nagano (JP)

(72) Inventors: Keita ARAI, Nagano (JP); Nanae NAITO, Nagano (JP); Koji TAKEI, Nagano (JP); Ryuji KOBAYASHI, Nagano (JP)

(21) Appl. No.: 19/457,808

(22) Filed: Jan. 23, 2026

(30) Foreign Application Priority Data
May 16, 2025 (JP) 2025-082303

(51) Int. Cl. B25B 13/48; B25B 23/00

(52) U.S. Cl. CPC B25B 13/48; B25B 23/0007

(57) ABSTRACT

Provided is a screw head replacement tool capable of reliably mating with a screw head and performing torque management. The screw head replacement tool is configured to include a plate-like central part, a first plate-like part continuously connected to the central part, a mating hole part penetrating the central part in a thickness direction thereof, and a connection part configured to be connected to a torque wrench. The mating hole part has protruding portions mating with recesses of a screw head, correspondingly.

### CROSS-REFERENCE TO RELATED APPLICATION

This application claims the priority benefit under 35 U.S.C. § 119 of Japanese Patent Application No. 2025-082303 filed on May 16, 2025, which is hereby incorporated in its entirety by reference.

### FIELD OF THE INVENTION

The present disclosure relates to a screw head replacement tool used for attaching and detaching a screw head of an injection device.

### BACKGROUND

A screw head replacement tool according to a conventional art is described, for example, in Patent Literature 1. Patent Literature 1 describes a screw head replacement tool that includes a ring body and a pair of handlebars. The ring body is attached to a screw head while enclosing the outer shape thereof, and has recesses formed on four sides thereof. The pair of handlebars has engaging claws at their distal ends for engaging the recesses of the screw head. In the conventional art, the screw head replacement tool is configured such that an insertion hole is bored at both sides of the ring body with the vertical positions of the insertion holes being offset relative to each other, and the distal ends of the handlebars are inserted through the insertion holes so that the pair of handlebars is secured to both sides of the ring body while the engaging claws at the distal ends engage with the recesses on both sides of the screw head and protrude into the ring body. With such a configuration, the conventional screw head replacement tool easily applies a rotational torque to the screw head.

In the screw head replacement tool according to the conventional art, the ring body is attached to the screw head and the distal ends of the pair of handlebars are inserted from the outside into the insertion holes formed in the ring body and engaged with the recesses of the screw head, thereby applying a rotational torque to the screw head. Therefore, if the engagement between the distal ends of the handlebars and the recesses of the screw head is insufficient, the recesses may be deformed. In addition, in the configuration of the conventional art, there is a problem that torque management cannot be performed.

An object of the present disclosure is to provide a screw head replacement tool capable of reliably mating with a screw head and performing torque management.

### BRIEF SUMMARY OF THE INVENTION

According to an aspect of the present disclosure, there is provided a screw head replacement tool used for a screw head, the screw head including a substantially conical head, a neck portion integrally formed in one axial direction of the head, and a threaded portion integrally formed in one axial direction of the neck portion, the head having a plurality of agitating blades that protrude radially outward from the axial center of the head and that are formed at circumferential intervals, and recesses formed between the adjacent agitating blades, the screw head replacement tool including: a plate-like central part; a first plate-like part continuously connected to the central part; a mating hole part penetrating the central part in a thickness direction thereof; and a connection part configured to be connected to a torque wrench, wherein the mating hole part has multiple protruding portions, each mating with one of the recesses.

In the present disclosure, the protruding portions each may have a protruding end surface configured to be in surface contact with a bottom surface of the recess.

In the present disclosure, the connection part may be detachably attached to the central part.

In the present disclosure, the connection part may be a hole that penetrates the central part in the thickness direction, and the hole may have a shape capable of mating with a torque wrench.

In the present disclosure, the connection part may be integrally formed at the distal end of the first plate-like part.

In the present disclosure, the screw head replacement tool may have an interchangeable central part configured to detachably mate with the central part, and the mating hole part may be formed in the interchangeable central part.

More specifically, the screw head replacement tool may have an interchangeable central part having the aforementioned mating hole portion and being detachable, wherein the central part has a hole into which the interchangeable central part can be detachably fitted, and by fitting the interchangeable central part into said hole, the mating hole portion penetrates the central part in the thickness direction.

According to the present disclosure, the screw head replacement tool has a central part where a mating hole part is formed, and the mating hole part has multiple protruding portions that are each capable of mating with one of the recesses of the screw head. When the screw head is inserted into the mating hole part, the protruding portions of the mating hole part can be mated with the recesses of the screw head. Thus, the screw head replacement tool and the screw head can be reliably mated with each other. Furthermore, since the screw head replacement tool has a connection part that is configured to be connected to a torque wrench, the screw head can be attached thereto while torque management is performed.

According to the present disclosure, when the protruding portions each have a protruding end surface that is in surface contact with the bottom surface of the recess, the protruding portion of the screw head replacement tool and the screw head recess can be reliably mated with each other.

According to the present disclosure, when the connection part is detachably provided in the central part, the connection part can be switched to match a connection part of a different torque wrench, and thus, a screw head replacement tool that can be connected to various torque wrenches can be realized.

According to the present disclosure, when the connection part is a hole that penetrates the central part in the thickness direction and the hole has a shape capable of mating with a torque wrench, a screw head replacement tool that can be connected to a torque wrench having a bar-shaped distal end can be realized.

According to the present disclosure, when the connection part is integrally formed at the distal end of the first plate-like part, torque management can be performed when a torque wrench is connected to the connection part.

According to the present disclosure, when the screw head replacement tool has an interchangeable central part configured to detachably mate with the central part and the mating hole part is formed in the interchangeable central part, the screw head replacement tool can be used for various screw heads of different sizes by preparing interchangeable central parts that have mating hole parts of different shapes and switching the interchangeable central part with another.

### BRIEF DESCRIPTION OF THE DRAWINGS

These and other characteristics, features, and advantages of the present disclosure will become clear from the following description with reference to the accompanying drawings, wherein:

FIG. 1 is a diagram illustrating relationships between a screw head replacement tool 1 according to an embodiment of the present disclosure, a screw head 2, and a torque wrench 3;

FIG. 2 is a diagram illustrating a state in which the screw head replacement tool 1 mates with the screw head 2 and the torque wrench 3 is connected to the screw head replacement tool 1;

FIG. 3 is a front view of the screw head replacement tool 1;

FIG. 4 is a diagram illustrating relationships between a screw head replacement tool 1A, a screw head 2, and a torque wrench 3;

FIG. 5 is a front view of the screw head replacement tool 1B;

FIG. 6 is a diagram illustrating relationships between the screw head replacement tool 1B, a screw head 2, and a torque wrench 3;

FIG. 7 is a front view of a screw head replacement tool 1C;

FIG. 8 is a diagram illustrating relationships between the screw head replacement tool 1C, a screw head 2, and a torque wrench 3;

FIG. 9 is a front view of a screw head replacement tool 1D; and

FIG. 10 is an exploded perspective view of the screw head replacement tool 1D.

### DETAILED DESCRIPTION OF THE INVENTION

### Screw Head

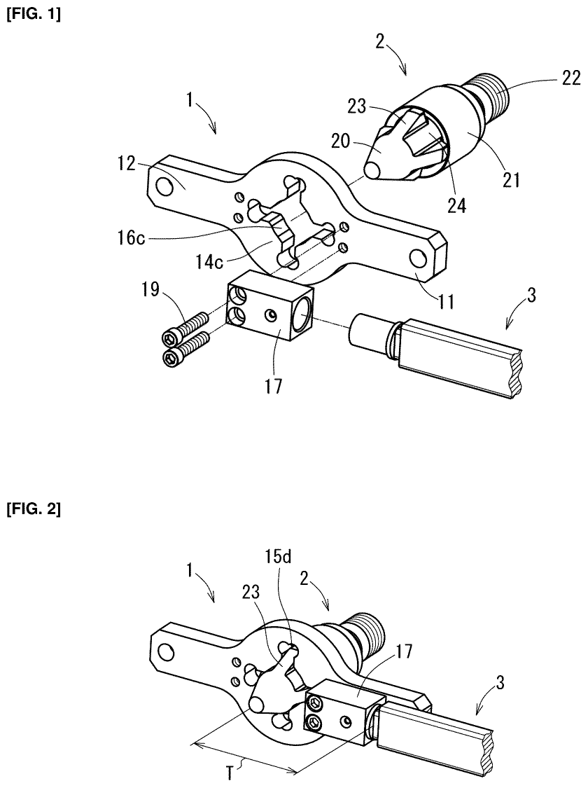

First, a screw head 2 for which a screw head replacement tool 1 according to the present disclosure can be used will be described. FIG. 1 is a diagram illustrating relationships between the screw head replacement tool 1 according to an embodiment of the present disclosure, the screw head 2, and a torque wrench 3. FIG. 2 is a diagram illustrating a state in which the screw head replacement tool 1 mates with the screw head 2 and the torque wrench 3 is connected to the screw head replacement tool 1.

The screw head 2 is configured to include a substantially conical head 20, a neck portion 21 integrally formed in one side of the head 20 in an axial direction, and a threaded portion 22 integrally formed in one side of the neck portion 21 in an axial direction. The head 20 is further configured to include four agitating blades 23 that protrude radially outward from the axial center of the head 20 and are formed at circumferential intervals. Recesses 24 are formed between the adjacent agitating blades 23.

An outer thread is formed on the threaded portion 22. When the threaded portion 22 is screwed to a screw main body (not shown), the screw head 2 is connected to the screw main body. The size of the screw head 2 is, for example, 80 mm to 160 mm in diameter. The tightening torque for the screw head 2 is set to, for example, 980 N·m.

### Screw Head Replacement Tool

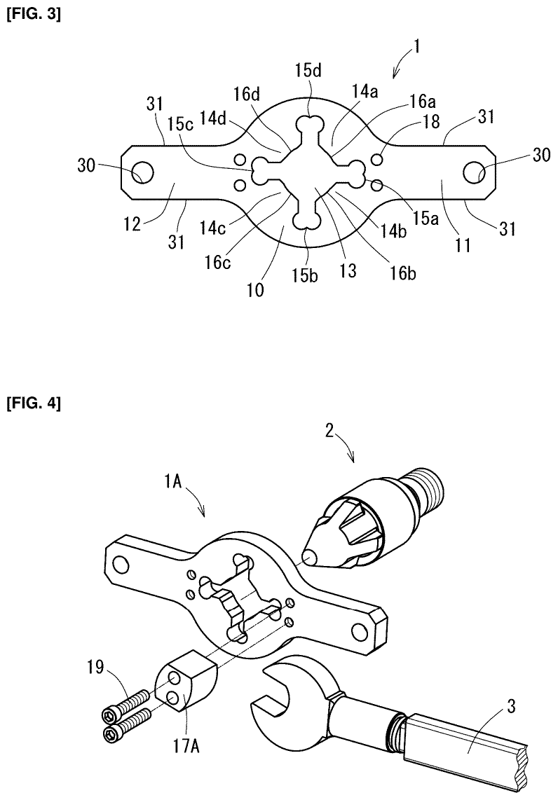

FIG. 3 is a front view of the screw head replacement tool 1. The screw head replacement tool 1 is configured to include a substantially disk plate-shaped central part 10, a first plate-like part 11 configured to extend in a direction perpendicular to the thickness direction and to be continuously connected to the central part 10, and a second plate-like part 12 configured to also be continuously connected to the central part 10 but extend in a direction opposite to the direction in which the first plate-like part 11 extends. The first plate-like part 11 and the second plate-like part 12 are configured to be point symmetrical with respect to the axial center of the screw head replacement tool 1. The screw head replacement tool 1 is made of a metal material and may be made of, for example, an alloy steel called SCM440.

A mating hole part 13 penetrating in the thickness direction is formed in the central part 10. The mating hole part 13 has four protruding portions 14a, 14b, 14c, and 14d that are configured to be mated with the recesses 24 of the screw head 2, respectively. Protruding end surfaces 16a, 16b, 16c, and 16d are formed at the distal ends of the respective protruding portions 14a, 14b, 14c, and 14d, and these surfaces are in surface contact with the bottom surfaces of the recesses 24 when the screw head replacement tool 1 is in a state of having been mated with the screw head 2. The widths of the protruding end surfaces 16a, 16b, 16c, and 16d are set to be substantially the same as those of the bottom surfaces of the recesses 24.

The mating hole part 13 has groove portions 15a, 15b, 15c, and 15d formed between the respective protruding portions 14a, 14b, 14c, and 14d. Each of the groove portions 15a, 15b, 15c, and 15d is recessed radially outward so that the agitating blades 23 of the screw head 2 can be mated therewith.

Screw holes 18 are formed in the central part 10 for receiving, by screw engagement, a connection part 17 configured to be connected to the torque wrench 3. The connection part 17 is screwed and fixed to a region between the central part 10 and the first plate-like part 11 by screws 19. In the present embodiment, the connection part 17 is configured to be an adapter for a torque wrench and has a mating hole to which the distal end (head) of the torque wrench 3 can be connected. When the torque wrench 3 is connected to the connection part 17, the screw head replacement tool 1 can apply a tightening torque to the screw head 2 while performing torque management.

As shown in FIG. 2, the screw head replacement tool 1 is used in a state where the screw head 2 is inserted into the mating hole part 13 and the screw head replacement tool 1 and the screw head 2 are thereby mated with each other. At this time, each of the agitating blades 23 is mated with each of the groove portions 15a to 15d so that the bottom surfaces of the recesses 24 are each facing and in contact with one of the protruding end surfaces 14a to 14d. The torque wrench 3 is used to apply a tightening torque to the screw head 2 in this state, and as a result, the tightening torque can be applied while the screw head replacement tool 1 and the screw head 2 are reliably mated (engaged) with each other. Therefore, it is possible to realize the screw head replacement tool 1 that reliably mates with the screw head 2 and is capable of performing torque management of the tightening torque can be realized.

A converted torque value when an offset adapter is used with the torque wrench 3 can be determined by multiplying the tightening torque by a value obtained by dividing the effective length of the torque wrench by the sum of the center distance of the offset adapter and the effective length of the torque wrench. As shown in FIG. 2, the screw head replacement tool 1 is configured such that, when the screw head 2 is mated, the distance T from the axial center of the screw head 2 to the connection part 17 connected to the torque wrench 3 is set to the same value as the center distance of the head of the torque wrench 3 to be used, that is, the offset distance is zero. Therefore, the torque can be accurately controlled by the torque wrench 3 without the need for any correction of the offset distance.

Since the first plate-like part 11 and the second plate-like part 12 are formed in the same shape, only the first plate-like part 11 will be described as a representative. The first plate-like part 11 is formed in a rectangular plate shape, and its base end portion is connected to the central part 10. A hole 30 that penetrates in the thickness direction is formed at the free end portion. The first plate-like part 11 has two end faces 31 extending in parallel with each other in the thickness direction.

When removing the screw head 2 from the screw main body, a user connects the torque wrench 3 to the screw head replacement tool 1 and rotates the torque wrench 3 together with the screw head replacement tool 1 and the screw head 2 in the loosening direction. When the screw head 2 is difficult to detach, the end face 31 can be struck by a hammer or the like to apply a torque in the loosening direction. The first plate-like part 11 and the second plate-like part 12 may be formed in different shapes from each other.

### Screw Head Replacement Tool 1A

FIG. 4 is a diagram illustrating relationships between a screw head replacement tool 1A according to a modification of the present disclosure, the screw head 2, and the torque wrench 3. The screw head replacement tool 1A is different from the screw head replacement tool 1 in that a connection part 17A is adopted instead of the connection part 17. The connection part 17A is formed into a square columnar shape that can be gripped with a spanner head, and is screwed to the screw head replacement tool 1A by screws 19. In this case, an adapter having a spanner head is attached to the distal end of the torque wrench 3.

According to the present embodiment, the torque wrench 3 having a spanner head can be used to apply a tightening torque to the screw head 2 while the screw head replacement tool 1A and the screw head 2 are reliably mated (engaged) with each other. Therefore, it is possible to realize the screw head replacement tool 1A that reliably mates with the screw head 2 and is capable of performing torque management of the tightening torque.

### Screw Head Replacement Tool 1B

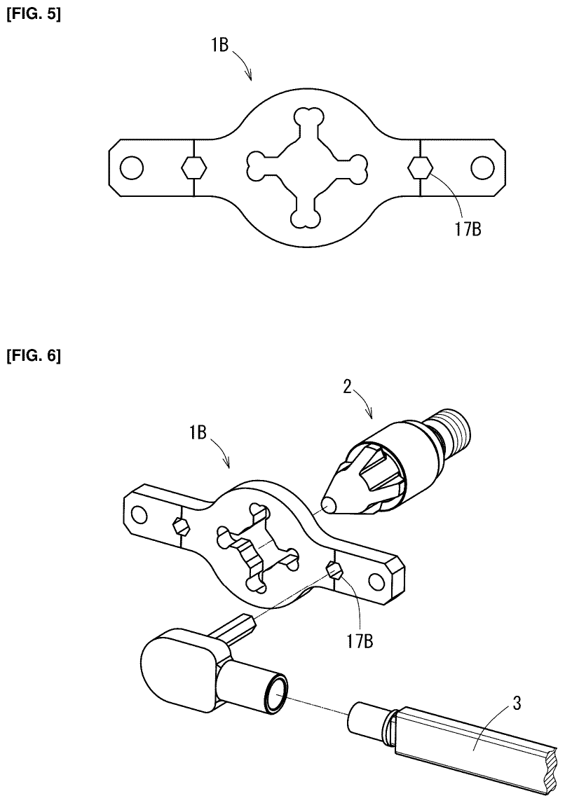

FIG. 5 is a front view of the screw head replacement tool 1B according to a modification of the present disclosure, and FIG. 6 is a diagram illustrating relationships between the screw head replacement tool 1B according to the modification of the present disclosure, a screw head 2, and a torque wrench 3. The screw head replacement tool 1B is different from the screw head replacement tool 1 in that a connection part 17B is adopted instead of the connection part 17, and the screw holes 18 are not formed.

The connection part 17B is realized by a hexagonal columnar through hole. In this case, an adapter having a hexagonal columnar insertion portion is attached to the head of the torque wrench 3. In the present embodiment, the screw head replacement tool 1B is configured such that, when the screw head 2 is mated, the distance from the axial center of the screw head 2 to the axial center of the connection part 17B is set equal to the center distance of the torque wrench head of the torque wrench 3 to be used. This allows the offset distance of the torque wrench 3 to be set to zero. As a result, the torque can be managed by the torque wrench 3 without correcting for any offset distance.

According to the present embodiment, the torque wrench 3 having an adapter having a hexagonal columnar insertion portion can be used to apply a tightening torque to the screw head 2 while the screw head replacement tool 1B and the screw head 2 are reliably mated (engaged) with each other. Therefore, it is possible to realize the screw head replacement tool 1B that reliably mates with the screw head 2 and is capable of performing torque management of the tightening torque.

### Screw Head Replacement Tool 1C

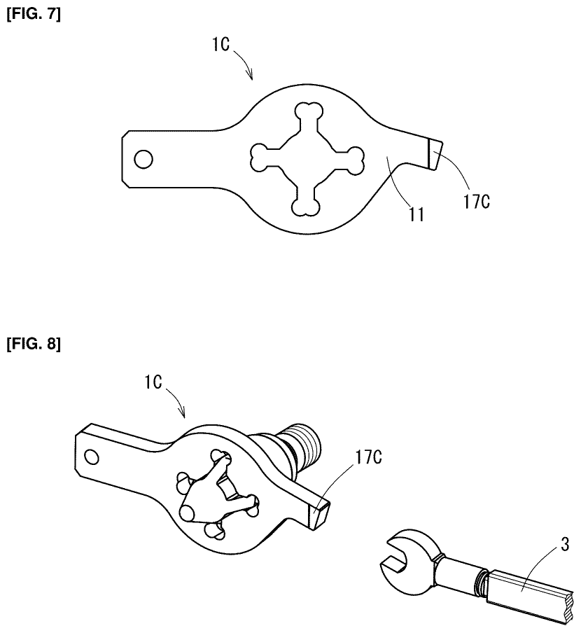

FIG. 7 is a front view of a screw head replacement tool 1C according to a modification of the present disclosure, and FIG. 8 is a diagram illustrating relationships between the screw head replacement tool 1C according to the modification of the present disclosure, the screw head 2, and the torque wrench 3. The screw head replacement tool 1C is different from the screw head replacement tool 1 in that a connection part 17C is adopted instead of the connection part 17, and a connection part 17C is integrally formed with the free end portion of the first plate-like part 11.

The connection part 17C is realized by a square columnar protruding portion. The connection part 17C is integrally formed with the free end portion of the first plate-like part 11. Therefore, in the present embodiment, the first plate-like part 11 and the second plate-like part 12 are not formed in the same shape. In this case, an adapter having a spanner head is attached to the head of the torque wrench 3.

According to the present embodiment, the torque wrench 3 having a spanner head can be used to apply a tightening torque to the screw head 2 while the screw head replacement tool 1C and the screw head 2 are reliably mated (engaged) with each other. Therefore, it is possible to realize the screw head replacement tool 1C that reliably mates with the screw head 2 and is capable of performing torque management of the tightening torque.

### Screw Head Replacement Tool 1D

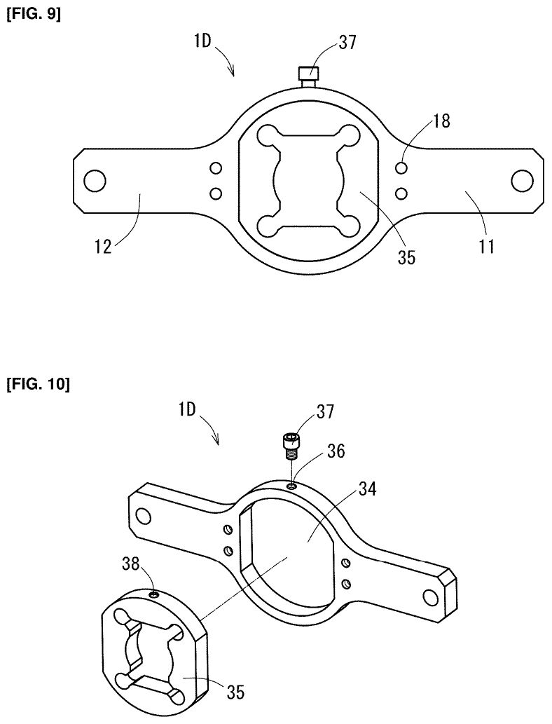

FIG. 9 is a front view of a screw head replacement tool 1D according to a modification of the present disclosure, and FIG. 10 is an exploded perspective view of the screw head replacement tool 1D according to the modification of the present disclosure. The screw head replacement tool 1D is different from the screw head replacement tool 1 in that the central part 10 has a different configuration. In FIGS. 9 and 10, the connection part 17 is omitted for ease of understanding.

In the screw head replacement tool 1D, an interchangeable part 35 is detachably attached to the central part 10. A mating hole part 13 is formed in the interchangeable part 35. The interchangeable part 35 is fixed by being mated with a mating hole 34 formed in the central part 10. A screw hole 36 extending in a direction perpendicular to both the longitudinal and thickness directions of the tool 1D is formed in the central part 10. Another screw hole 38 is formed in the interchangeable part 35 at a position corresponding to the screw hole 36 of the central part 10.

The interchangeable part 35 can be attached by inserting and mating the interchangeable part 35 into the mating hole 34 and screwing a screw 37 into the screw hole 36. According to the present embodiment, by designing the shapes of the mating hole parts 13 formed in various interchangeable parts 35 to match the outer diameters of screw heads 2 having different shapes, the screw head replacement tool 1D can be configured to allow attachment and detachment of a plurality of types of screw heads 2 simply by replacing the interchangeable part 35.

According to the present embodiment, the torque wrench 3 having a spanner head can be used to apply a tightening torque to the screw head 2 while the screw head replacement tool 1D and the screw head 2 are reliably mated (engaged) with each other. Therefore, it is possible to realize the screw head replacement tool 1D that reliably mates with the screw head 2 and is capable of performing torque management of the tightening torque.

Although the embodiments of the present disclosure have been described in detail, the present disclosure is not limited to the above-described embodiments, and various modifications and improvements can be made thereto without departing from the spirit of the present disclosure. Needless to say, all or part of each of the above-described embodiments can be combined as appropriate, provided that contradictions are not present.

### REFERENCE SIGNS LIST

1, 1A, 1B, 1C, 1D screw head replacement tool
2 screw head
3 torque wrench
10 central part
11 first plate-like part
12 second plate-like part
13 mating hole part
14a to 14d protruding portion
15a to 15d groove portion
16a to 16d protruding end surface
17, 17A to 17C connection part
23 agitating blade
24 recess
30 hole
31 end face
34 mating hole
35 interchangeable part

### CITATION LIST

Patent Literature 1: Japanese Registered Utility Model Publication No. Hei. 07-053957

What is claimed is:

1. A screw head replacement tool used for a screw head, the screw head having a substantially conical head, a neck portion integrally formed in one axial direction of the head and a threaded portion integrally formed in one axial direction of the neck portion, the head having a plurality of agitating blades that protrude radially outward from an axial center of the head and that are formed at circumferential intervals and a plurality of recesses formed between the adjacent agitating blades, the screw head replacement tool comprising:
a plate-like central part;
a first plate-like part continuously connected to the central part;
a mating hole part penetrating the central part in a thickness direction thereof; and
a connection part configured to be connected to a torque wrench, the mating hole part having multiple protruding portions, each mating with one of the plurality of recesses.

2. The screw head replacement tool according to claim 1, wherein the protruding portions of the mating hole each have a protruding end surface and each recess has a bottom surface, the protruding end surface being configured to be in contact with the bottom surface of the recess.

3. The screw head replacement tool of claim 1, wherein the connection part is removably secured to the central part.

4. The screw head replacement tool according to claim 1, wherein the connection part is a hole that penetrates the central part in the thickness direction.

5. The screw head replacement tool according to claim 4, wherein the hole has a shape capable of mating with a torque wrench.

6. The screw head replacement tool according to claim 1, wherein the connection part is integrally formed at a distal end of the first plate-like part.

7. The screw head replacement tool according to claim 1, comprising an interchangeable central part configured to detachably mate with the central part.

8. The screw head replacement tool according to claim 7, wherein the mating hole part is formed in the interchangeable central part.

9. The screw head replacement tool of claim 1, wherein the connection part is removably secured to the central part.

10. The screw head replacement tool according to claim 1, wherein the connection part is a hole that penetrates the central part in the thickness direction.

11. The screw head replacement tool according to claim 10, wherein the hole has a shape capable of mating with a torque wrench.

12. The screw head replacement tool according to claim 1, wherein the connection part is integrally formed at a distal end of the first plate-like part.

13. The screw head replacement tool according to claim 1, comprising an interchangeable central part configured to detachably mate with the central part.

14. The screw head replacement tool according to claim 13, wherein the mating hole part is formed in the interchangeable central part.
